(19) United States
(12) Patent Application Publication
(10) Pub. No.: US 2025/0306669 A1
(43) Pub. Date: Oct. 2, 2025

(54) ELECTRONIC DEVICE AND CONTROL METHOD THEREOF

(71) Applicant: Lenovo (Beijing) Limited, Beijing (CN)

(72) Inventors: Guangming REN, Beijing (CN); Qi SHEN, Beijing (CN)

(21) Appl. No.: 19/080,633

(22) Filed: Mar. 14, 2025

(30) Foreign Application Priority Data
Mar. 29, 2024 (CN) 202410381550.6

(51) Int. Cl. G06F 1/3296; G06F 1/16; G06F 1/3212; G06F 1/3231; G06F 1/3246; H02J 7/00

(52) U.S. Cl. CPC G06F 1/3296; G06F 1/1616; G06F 1/3212; G06F 1/3231; G06F 1/3246; H02J 7/0048

(57) ABSTRACT

A control method for an electronic device including determining a set time threshold in response to a user trigger input; if a duration of the electronic device being in a first shutdown state and the time threshold meet a preset condition, controlling the electronic device to be in a second shutdown state; if the electronic device is in the first shutdown state, causing a power module of the electronic device to provide power to a control system of the electronic device through a power circuit; and if the electronic device is in the second shutdown state, causing the power module of the electronic device to stop providing power to the control system and causing the electronic device to enter a power saving mode.

### CROSS-REFERENCES TO RELATED APPLICATION

This application claims priority to Chinese Patent Application No. 202410381550.6 filed on Mar. 29, 2024, the entire content of which is incorporated herein by reference.

### FIELD OF TECHNOLOGY

The present disclosure relates to the field of power management technology of electronic devices and, more specifically, to an electronic device and a control method thereof

### BACKGROUND

To meet the requirements of portability, space utilization, energy management, safety, maintenance convenience, and performance stability, many electronic devices are equipped with power modules that can store and provide electrical energy.

At present, in the case of a long-term shutdown of electronic devices with integrated power modules and no external power supply, the electronic devices will enter a power saving mode to reduce the power consumption of the batteries in the power modules. Current electronic devices enter the power saving mode in a fixed and unique control mode after being turned off, which is inconvenient for users.

### SUMMARY

One aspect of this disclosure provides a control method for an electronic device. The control method includes determining a set time threshold in response to a user trigger input; if a duration of the electronic device being in a first shutdown state and the time threshold meet a preset condition, controlling the electronic device to be in a second shutdown state; if the electronic device is in the first shutdown state, causing a power module of the electronic device to provide power to a control system of the electronic device through a power circuit; and if the electronic device is in the second shutdown state, causing the power module of the electronic device to stop providing power to the control system and causing the electronic device to enter a power saving mode.

Another aspect of this disclosure provides an electronic device. The electronic device includes a control system and a power module. The power module is connected to the control system via a power circuit. The control system is configured to respond to a user trigger input, determine a set time threshold, and if a duration of the electronic device in a first shutdown state and the time threshold meet a preset condition, control the electronic device to be in a second shutdown state. If the electronic device is in the first shutdown state, the control system is configured to cause the power module of the electronic device to provide power to the control system of the electronic device through the power circuit. If the electronic device is in the second shutdown state, the control system is configured to cause the power module of the electronic device to stop providing power to the control system and cause the electronic device to enter a power saving mode.

### BRIEF DESCRIPTION OF THE DRAWINGS

To clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

The structure, scale, size, etc. shown in the drawings of this specification are for the purpose of only matching the content disclosed in the specification for those who are familiar with the technologies to understand and read, rather than limiting the conditions under which the present application is to be implemented, and therefore have no technical significance. Any modification to the structure, change to the scale or the size without affecting the functions and the purpose of the present application shall still fall within the scope covered by the embodiments disclosed in the present application.

FIG. 1 is a schematic diagram of an example internal circuit connection of an electronic device according to some embodiments of the present disclosure.

FIG. 2 is a flowchart of an electronic device control method according to some embodiments of the present disclosure.

FIG. 3 is a flowchart of a method for determining whether a preset condition is met according to some embodiments of the present disclosure.

FIG. 4 is a flowchart of the method for determining whether the preset condition is met according to some embodiments of the present disclosure.

FIG. 5 is a flowchart of a method for setting a time threshold according to some embodiments of the present disclosure.

FIG. 6 is a flowchart of the method for setting the time threshold according to some embodiments of the present disclosure.

FIG. 7 is a flowchart of the electronic device control method according to some embodiments of the present disclosure.

FIG. 8 is a schematic diagram of an example internal circuit connection of the electronic device according to some embodiments of the present disclosure.

FIG. 9 is a flowchart of a method for controlling a power supply module to exist a power saving mode according to some embodiments of the present disclosure.

FIG. 10 is a flowchart of the electronic device control method according to some embodiments of the present disclosure.

FIG. 11 is a schematic structural diagram of an example power wake-up circuit according to some embodiments of the present disclosure.

FIG. 12 is a schematic diagram of an example internal circuit connection of the electronic device according to some embodiments of the present disclosure.

FIG. 13 is a circuit diagram of an example power module according to some embodiments of the present disclosure.

FIG. 14 is a schematic diagram of an example circuit connection of a power button according to some embodiments of the present disclosure.

FIG. 15 is a schematic diagram of an example pin connection method of a power control chip according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

A power module may include an integrally packaged battery and a battery management circuit, and the battery management circuit may include at least a power control chip for controlling the working state of the power module. The power module can provide power to the control system of the electronic device for the control system to control the electronic device to perform various functions based on the power provided by the power module.

In conventional electronic devices, after the electronic device is turned off, the battery in the power module will maintain the power supply state with the control system. Accordingly, the control system can perform some functions without the help of external power supply. For example, the control system can respond to the power-on signal in the off state and control the electronic device to start up.

At present, if there is no external power input for a long time after the electronic device is turned off, when the battery power is less than 30% and the duration is more than 2 weeks, the electronic device will control the battery module to enter the power saving mode. At this time, the power module will stop supplying power to the control system to reduce battery power consumption and prevent the battery from over-discharging, thereby facilitating long-term storage and transportation of the electronic device.

On the one hand, the control process of the electronic device entering the power saving mode after being turned of is fixed and cannot be adjusted. On the other hand, when there is no external power supply for a long time after shutdown, the electronic device can only be triggered to switch the power module to power saving mode if the battery power is less than 30% and the state lasts for more than 2 weeks. After the electronic device is turned off, this control method will cause the battery to discharge at 45 W/h for up to 93.75 days, which will not only waste power but also affect the battery life.

In view of the above, the embodiments of the present disclosure provide an electronic device and a control method thereof that can cause the electronic device to respond to the user's trigger input, determine the set time threshold, and control the electronic device to be in a second shutdown state if the duration of the electronic device being in the shutdown state and the time threshold meet the preset condition. If the electronic device is in the first shutdown state, the power module of the electronic device provides power to the control system of the control system through a power circuit. If the electronic device is in the second shutdown state, the power module of the control system stops providing power to the control system to enter a power saving mode.

The technical solutions provided in the present disclosure can control the process of an electronic device entering the second shutdown state from the first shutdown state by adjusting a time threshold. Accordingly, the process of the electronic device entering the second shutdown state from the first shutdown state can be adjusted, which is convenient for user.

In some embodiments, the electronic device allows the user to set the time threshold, and can flexibly control the process of the electronic device entering the second shutdown state from the first shutdown state. When the user determines the usage schedule, the user can set the time threshold accordingly. After the electronic device is shut down and enters the first shutdown state, the electronic device can enter the second shutdown state more promptly, thereby shortening the wait time for switching from the first shutdown state to the second shutdown state for the power module to enter the power saving mode in time. This prevents the power of the battery in the power module from being in the first shutdown state for a long time, thereby preventing the power from being wasted for a long time.

Based on the technical solutions provided in the embodiments of the present disclosure, after the electronic device is shut down in a fully charged state, the electronic device can enter the second shutdown state in time based on the time threshold set by the user. Accordingly, the time it takes for the electronic device to enter the second shutdown state from the first shutdown state is reduced, the unnecessary discharge consumption of the electronic device in the first shutdown state for a long time is reduced, the battery life when the system is shut down is improved, and the service life is extended. In the second shutdown state, the battery itself consumes relative low power (approximately 1.89 mW). By setting the time threshold, the electronic device can quickly switch from the first shutdown state to the second shutdown state, such that the electronic device can maintain power during storage for up to 33 months (approximately 2 years and 9 months).

To make the objectives, features and advantages of the present disclosure described above more clearly understood, the present disclosure is further described in detail below with reference to accompanying drawings and embodiments.

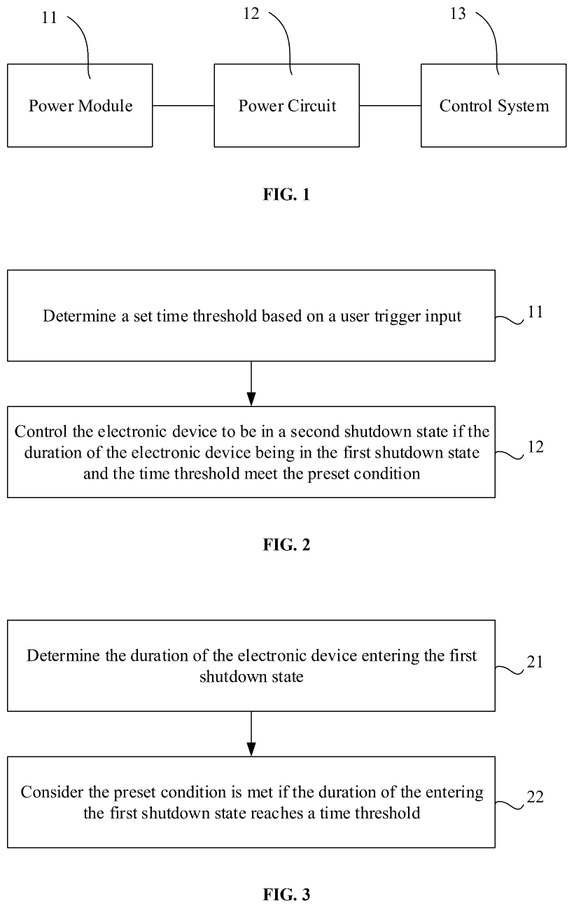

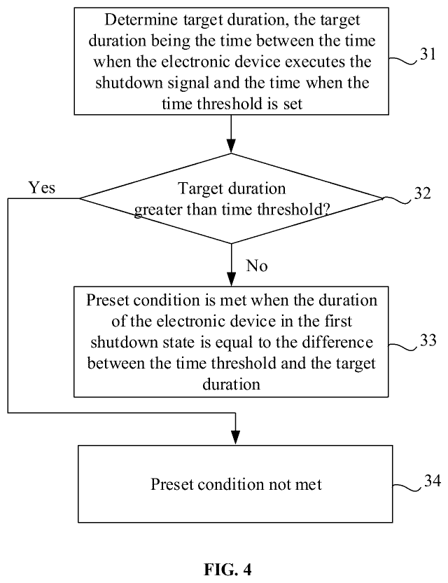

FIG. 1 is a schematic diagram of an example internal circuit connection of an electronic device according to some embodiments of the present disclosure, and FIG. 2 is a flowchart of an electronic device control method according to some embodiments of the present disclosure. As shown in FIG. 1, the internal circuit of the electronic device includes a power module 11, a power circuit 12 and a control system 13. The control method of the electronic device will be described in detail below.

11, determining a set time threshold in response to a user trigger input.

12, controlling the electronic device to be in the second shutdown state if the duration of the electronic device being in the first shutdown state and the time threshold meet a preset condition.

In some embodiments, if the electronic device is in the first shutdown state, the power module 11 of the electronic device can provide power to the control system 13 of the electronic device through the power circuit 12.

In some embodiments, if the electronic device is in the second shutdown state, the power module 11 of the electronic device can stop providing power to the control system 13 and cause the electronic device to enter the power saving mode. The switch in the power module 11 can be turned off to shut down the external output of the battery in the power module 11, thereby stopping the power module 11 from supplying power to the control system 13.

Consistent with the present disclosure, the user can control the process of the electronic device entering the second shutdown state from the first shutdown state by adjusting the time threshold. Accordingly, the process of the electronic device entering the second shutdown state from the first shutdown state is adjustable and the user can set the time threshold based on the usage requirements to regulate the process.

When the control system is shut down normally, the control system will close the running programs and stop the background services, the hardware operation of the electronic device will stop, and enter the first shutdown state, at which the electronic device is in the so-called shutdown mode.

In the first shutdown state, although the electronic device shots down external programs and services, the power module 11 still maintains a connection state with the control system 13 through the power circuit 12, and can provide power to the control system 13. Accordingly, the control system 13 can maintain some functions in the first shutdown state, such as responding to the power-on signal, controlling the electronic device to start up, and maintaining the CMOS settings (including system configuration and hardware information, etc.). In the first shutdown state, the power module 11 can also supply power to a real-time clock chip (RTC) to reduce the consumption of clock power.

In the second shutdown state, the power module 11 stops providing power to the control system 13 to enter a power saving mode, also known as a shipping mode. in the second shutdown state, the power module 11 is configured to have the lowest quiescent current mode, thereby entering the power saving mode. At this time, the TRC provides working voltage through the clock power supply to maintain the accuracy of the system date and time. The clock power supply may be a CMOS power supply such as a button battery.

The RTC is not shown in FIG. 1. In some embodiments, the RTC may be connected to the control system 13 and the CMOS power supply respectively. In this case, when the computer is turned on or is the first shutdown state, the control system 13 can provide power to the RTC through the power module 11 or an external power supply connected to the electronic device. In the second shutdown state, the RTC can be powered by the CMOS power supply.

If the electronic device enters the second shutdown state, the power module 11 can be in a power saving mode, which can minimize the power consumption of the battery in the power module 11 after the electronic device is shut down for a certain period of time and no external power is connected to prevent excessive discharge of the battery in the power module 11 and facilitate long-term storage and transportation of electronic devices. In the second shutdown state, the power module 11 will be disconnected from the power circuit 12, thereby stopping supplying power to the control system 13.

FIG. 3 is a flowchart of a method for determining whether a preset condition is met according to some embodiments of the present disclosure. The method will be described in detail below.

21, determining a duration for which the electronic device enters the first shutdown state.

22, determining that the preset condition is met if the duration of the electronic device entering the first shutdown state reaches a time threshold.

Based on the embodiment shown in FIG. 3, after the electronic device enters the first shutdown state, the duration of the first shutdown state can be recorded. When the duration meets the set time threshold, it is determined that the preset condition is met. If the duration does not reach the set time threshold, the preset condition is not met. Accordingly, when the user sets the required time threshold, after the electronic device is turned off and enters the first shutdown state, as time goes by, the preset condition can be ultimately met for the electronic device to enter the second shutdown state to cause the power module 11 to enter the power saving mode.

Using the control method shown in FIG. 3, based on the time threshold set by the user, when the electronic device is turned off and enters the first shutdown state, based on the duration of the first shutdown state and the time threshold, the electronic device can be automatically controlled to switch from the first shutdown state to the second shutdown state. Accordingly, after the user sets the time threshold, whether the electronic device is turned off directly or not, the control of the electronic device from the first shutdown state to the second shutdown state after the shutdown is not affected.

Take a laptop as an example. If the user sets the time threshold to 20 hours, when the laptop is shut down and enters the first shutdown state, based on the control method shown in FIG. 3, the laptop can automatically switch to the second shutdown state after the duration in the first shutdown state reaches 20 hours.

It should be noted that in the embodiments of the present disclosure, the electronic device is not limited to a laptop, but may also be other electronic devices having a power module 11, such as a tablet, a mobile phone, an all-in-one computer, and a wearable device. The embodiments of the present disclosure do not limit the type of the electronic device.

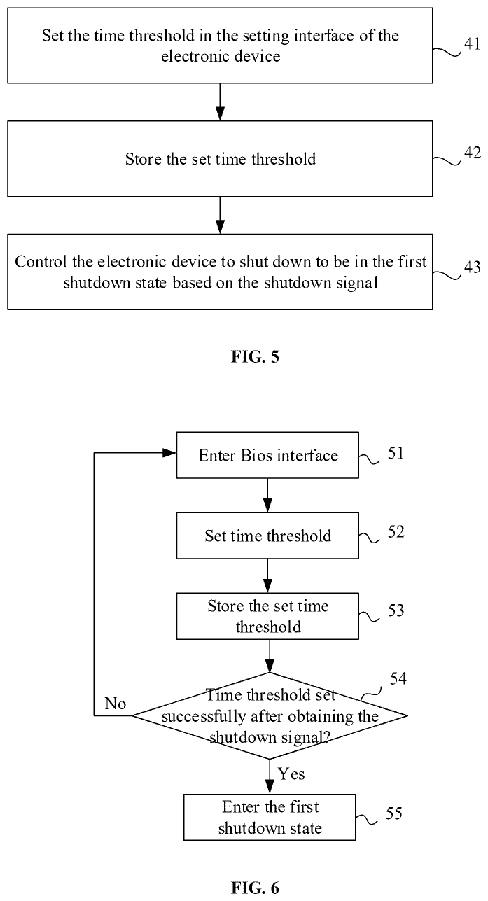

FIG. 4 is a flowchart of the method for determining whether the preset condition is met according to some embodiments of the present disclosure. The method will be described in detail below.

31, determining a target duration, the target duration being the time between the time when the electronic device executes the shutdown signal and the time when the set time threshold is completed.

32, determining whether the target duration is greater than the time threshold.

33, if the target duration is not greater than the time threshold, determining that the preset condition is met when the duration of the electronic device in the first shutdown state is equal to a difference between the time threshold and the target duration.

When the target duration is not greater than the time threshold, if the target duration is equal to the time threshold, the difference is 0, and after the electronic device is turned off and enters the first shutdown state, the electronic device can be directly switched from the first shutdown state to the second shutdown state without any wait time. If the target duration is less than the time threshold, after the electronic device is turned off and enters the first shutdown state, as time goes by, the preset condition can be ultimately met, and the electronic device enters the second shutdown state to cause the power module 11 to enter the power saving mode.

34, determining that the preset condition is met if the target duration is not greater than the time threshold.

In the embodiment shown in FIG. 4, after the user sets the time threshold, the electronic device does not directly shut down and enter the first shutdown state. The electronic device shuts down and enters the first shutdown state after a period of time after the user sets the time threshold. If the target duration is not greater than the time threshold, it can be determined, based on the duration being in the first shutdown state and the difference, that the present condition is met. If the target duration is greater than the time threshold, the preset condition is not met.

In the embodiment shown in FIG. 4, if the target duration is greater than the time threshold, after determining that the preset condition is not met, the method may also include: after the duration of the first shutdown state reaches a fixed duration, and/or the power level of the battery in the power module 11 is less than a target threshold, controlled the electronic device to enter the second shutdown state.

Using the control method shown in FIG. 4, the electronic device does not shut down directly after the user sets the time threshold, but runs for a certain period of time before shutting down and entering the first shutdown state. After determining that the preset condition is met, the electronic device can be automatically controlled to switch from the first shutdown state to the second shutdown state. After determining that the preset condition is not met, the electronic device can be automatically controlled to switch from the first shutdown state to the second shutdown state based on a fixed duration and/or battery power.

Take a laptop as an example. Using the control method shown in FIG. 4, if the user sets the time threshold to 8 hours, and electronic device continues to run for 6 hours and then shuts down and enters the first shutdown state. Based on the control method shown in FIG. 4, the time threshold is 8 hours, the target duration is 6 hours, and the difference between the time threshold and the target duration is 2 hours. Therefore, 2 hours after the electronic device enters the first shutdown state, the electronic device can be automatically switched to the second shutdown state. If the user sets the time threshold, and the electronic device continues to run for 10 hours and then enters shuts down and enters the first shutdown state. The target duration is 10 hours, which is greater than the time threshold, and the preset condition is not met. In this case, the electronic device can be automatically controlled to enter the second shutdown state after the duration of the first shutdown state reaches a fixed duration and/or the battery power in the power module 11 is less than the target threshold.

In the embodiment shown in FIG. 4, the usage time (i.e., the target duration) between the time threshold set by the user and the time when the electronic device is turned off is a factor affecting the preset condition. If the time threshold is less than the target duration, the set time threshold will be invalid and the preset condition will not be met, resulting in the electronic device being unable to control the electronic device to switch from the first shutdown state to the second shutdown state in time based on the time threshold set by the user. For this situation, the user's expected usage time may be used as a reference for the target duration, and a time threshold may be set such that the electronic device can be switched from the first shutdown state to the second shutdown state in a timely manner after being shut down. For example, the time threshold may be set to be greater than the expected usage time, and the difference between the two may not exceed target value. The target value can be set based on needs, such as 1 hour.

Based on the embodiment shown in FIG. 4, if the user's expected usage time is 5 hours, the user can set a time threshold greater than 5 hours. For example, if the target value is 0.5 hours, the time threshold may be 5.5 hours. If the electronic device is turned off 4 hours after setting the time threshold, the target duration is 4 hours, and the difference between the time threshold and the target duration is 1.5 hours. In this case, the electronic device can switch to the second shutdown state 1.5 hours after entering the first shutdown state.

FIG. 5 is a flowchart of a method for setting a time threshold according to some embodiments of the present disclosure. The method will be described in detail below.

41, setting the time threshold in a setting interface of the electronic device.

42, storing the time threshold setting.

After the time threshold is successfully set, the control system 13 can store the time threshold in the power control chip of the power module 11. After the electronic device is shut down and enters the first shutdown state, the power control chip in the power module 11 may automatically enter the power saving mode after determining that the preset condition is met based on the time threshold.

43, controlling the electronic device to shut down to be in the first shutdown state based on a shutdown signal.

In the embodiment shown in FIG. 5, the user may perform human-computer interaction through the setting interface of the electronic device to set the time threshold.

In some embodiments, the electronic device may be configured to respond to the user trigger inputs and set time thresholds. The time threshold may be set to any length, such as 4 hours, 12 hours, 24 hours, 48 hours, 72 hours, etc. The time threshold is not limited to only including setting integer hours, and may include setting hours and minutes.

In some embodiments, the electronic device may determine the time threshold currently set by the user based on the value input by the user.

In some embodiments, the electronic device may also pre-store a plurality of different time thresholds as shown in Table 1 below, and the user may set one of the time thresholds as the currently set time threshold.

TABLE 1
Embedded Controller Battery Setting True Value Table

| Project | Time Threshold/h | Time Identifier |
|---|---|---|
| 1 | 4 | 0A |
| 2 | 12 | 0B |
| 3 | 24 | 0C |
| 4 | 48 | 0D |
| 5 | 72 | 0E |

The control system 13 may include an embedded controller (EC). The electronic device may pre-store a plurality of different time thresholds as shown in Table 1 for the user to select, thereby determining the time threshold currently set by the user. Different time thresholds may correspond to different time identifiers. The power module 11 may be configured to determine the time threshold currently set by the user based on the time identifier sent by the EC, and store the time threshold. After the electronic device is turned off, the power control chip may control the power module 11 to enter the power saving mode based on the time. The power module 11 may stop outputting power to the control system based on the time threshold and enters the power saving mode after determining that the preset condition is met.

Take the electronic device is a laptop as an example. The setting interface for setting the time threshold may be a Windows interface, and the setting interface may be displayed in the form of icons and/or menus to more intuitively display the setting interface for setting the time threshold to the user. The setting interface for setting the time threshold may also be a Bios interface, and the setting interface may be displayed based on a simple text mode interface.

When the setting interface is the Bios interface, the method for setting the time threshold can be as shown in FIG. 6. FIG. 6 is a flowchart of the method for setting the time threshold according to some embodiments of the present disclosure. The method will be described in detail below.

51, entering the Bios interface. 52, setting the time threshold.

53, storing the time threshold setting.

54, determining whether the time threshold setting is successful after receiving the shutdown signal.

55, controlling the electronic device to shut down to be in the first shutdown state if the time threshold setting is successful.

If the time threshold is not set successfully, return to the Bios interface to reset the time threshold.

For the electronic device in the second shutdown state, since the power module 11 stops supplying power to the control system 13, the control system 13 is in the shutdown state. When there is a need to control the electronic device to start up, the control system 13 needs to be first powered to start up, and then the electronic device can be controlled to start up based on the control system 13.

Based on the above description, after the electronic device enters the second shutdown state, the control method provided in the embodiments of the present disclosure may also include: supplying power to the control system 13 to start the control system 13. In some embodiments, the control system 13 after startup may respond to the startup signal and control the electronic device to start up. After being started, the control system 13 may also control the power module 1 to exit the power saving mode to cause the electronic device to switch from the second shutdown state to the first shutdown state. The power module 11 may form a path based on the power circuit 12 and the control system 13. After the electronic device obtains the startup signal, the control system 13 in the startup state may control the electronic device to start up.

In some embodiments, the power circuit 12 may have an external power interface for connecting to an external power source. The external power interface may be connected to the external power source via a power adapter. The external power interface may be a Type-C interface or other types of interfaces. If the electronic device is in the on state, the electronic device may be connected to an external power source through the external power interface, and the external power source may provide the electronic device with the power required for operation, and may also charge the power module 11. If the electronic device is in a shutdown state, the electronic device may be connected to an external power source through an external power source interface, and the power module 11 may be charged through the external power source.

In some embodiments, after the electronic device enters the second shutdown state, the method of supplying power to the control system 13 may further include: connecting the power circuit 12 to an external power source, the power circuit 12 being configured to supply power to the control system 13 through the external power source to start the control system 13. At the time, the external power source can supply power to the control system 13 and can also charge the power module 11 through the power circuit 12.

As described above, when the electronic device is in the second shutdown state, the electronic device may be connected to an external power source through the power circuit 12 to provide power to the control system 13 to start the control system. After the control system 13 is started, if the power circuit 12 remains connected to the external power source, the control system 13 can respond to the control instruction based on the power provided by the external power source and control the electronic device to start up. If the power circuit 12 is disconnected from the external power source after the control system 13 is started but before the startup signal is obtained, since the connection with the power module 11 has been restored after the control system 13 is started, the control system 13 can respond to the control instruction and control the electronic device to start up based on the power provided by the power module 11.

In some embodiments, if the control system 13 is started by connecting to an external power source, after the electronic device is successfully connected to the external power source and the control system 13 is started by the external power source, the electronic device may be automatically controlled to start up. Accordingly, the self-starting of the control system 13 and the startup control of the electronic device can be realized simultaneously only by connecting to the external power source.

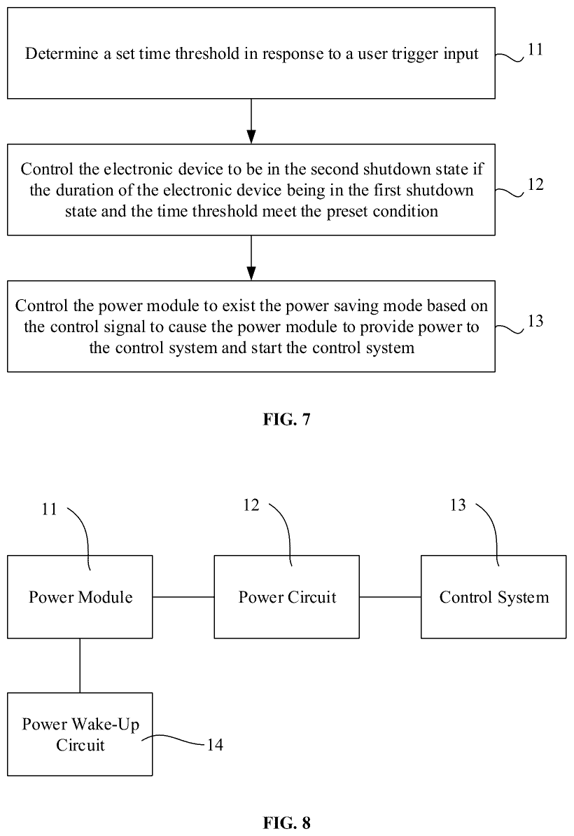

FIG. 7 is a flowchart of the electronic device control method according to some embodiments of the present disclosure. Based on any of the foregoing embodiments, in the control method shown in FIG. 7, when the electronic device is in the second shutdown state, the method may further include the following processes.

13, controlling the power module 11 to exit the power saving mode based on a control signal to cause the power module 11 to provide power to the control system and start the control system 13.

In some embodiments, the power module 11 may provide power to the started control system 13 through the power circuit 12, thereby controlling the electronic device to start up through the control system. In this case, the control signal may represent the startup signal. After the control system 13 controls the power module 11 to exit the power saving mode, the power supply path of the power module 11 to the control system 13 can be restored. After startup, the control system 13 can automatically control the electronic device to start up based on the power provided by the power module 11.

In the embodiment shown in FIG. 7, for the electronic device in the second shutdown state, the power module 11 can be controlled by a control signal to exit the power saving mode. Accordingly, the power module 11 can supply power externally and restore the path to the power circuit 12. The control system 13 can be powered by the power circuit 12 to start the control system 13 to cause the control system 13 to control the electronic device to start up. Accordingly, the power module 11 can be controlled to exit the power saving mode based on the control signal and restore the power supply to the control system 13. The electronic device can be controlled to exit the second shutdown state without connecting the electronic device to an external power source, and the control system 13 can control the electronic device to start up after being started based on the power provided by the power module 11.

In some embodiments, when the electronic device is in the second shutdown state, the external power source may be connected through the power circuit 12, and the control system 13 may be started through the external power source. Alternatively, based on the control signal generated when there is no external power source assistance, the power module 11 may be controlled to exit the power saving mode and the control system 13 may be started through the power module 11. The electronic device can respond to the user operations and perform any of the above methods to start the control system 13.

FIG. 8 is a schematic diagram of an example internal circuit connection of the electronic device according to some embodiments of the present disclosure. As shown in FIG. 8, the electronic device may also include a power wake-up circuit 14 connected to the power module 11. Based on this, the control method of the electronic device may further include: turning on the power wake-up circuit 14 connected to the power module 11 to generate a control signal though the power wake-up circuit 14 based on a preset user operation.

In some embodiments, when the electronic device is in the second shutdown state, the electronic device may be configured to detect a preset user operation and start the power wake-up circuit 14 arranged inside the electronic device. The power wake-up circuit 14 may generate a control signal such that the power module 11 can be controlled to exit the power saving mode through the control signal. Accordingly, the electronic device can be controlled to start up without connecting to an external power source.

In some embodiments, the electronic device may include a trigger unit connected to the power wake-up circuit 14 for detecting the preset user operation. When the trigger unit is triggered based on the preset user operation, the power wake-up circuit 14 can be turned on.

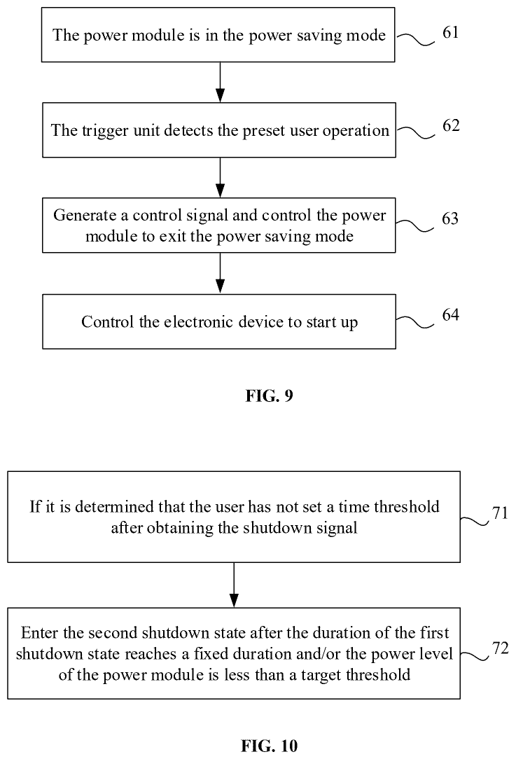

FIG. 9 is a flowchart of a method for controlling a power supply module to exist a power saving mode according to some embodiments of the present disclosure. The method will be described in detail below.

61, if the electronic device enters the second shutdown state, the power module 11 is in the power saving mode.

62, after the power module 11 is in the power saving mode, detecting the user operation through the trigger unit. If the trigger unit detects the preset user operation, proceed to the process at 63.

63, when the preset user operation is detected by the trigger unit, generating a control signal based on the built-in power wake-up circuit 14 to control the power module 11 to exit the power saving mode.

64, after the power module 11 exits the power saving mode, restoring the power to the control system 13 to start the control system 13.

In some embodiments, as shown in FIG. 9, the control system 13 may automatically control the electronic device to start up after being started. At this time, based on the same user operation, the power wake-up circuit 14 may be turned on to control the power module 11 to exit the power saving mode, thereby starting the control system 13, and the electronic device may be automatically turned on by the started control system 13.

In other embodiments, after the power module 11 exits the power saving mode based on the control signal, power may be provided to the control system 13. After the control system 13 is started, the electronic device may be controlled to switch from the second shutdown state to the first shutdown state. In the first shutdown state, after obtaining the startup signal input by the user, the control system 13 may control the electronic device to start up again. If there no startup instruction, the electronic device may remain in the first shutdown state. If no startup signal is obtained for an extended period of time after being in the first shutdown state, the electronic device may be controlled to enter the second shutdown state again based on any of the foregoing implementations.

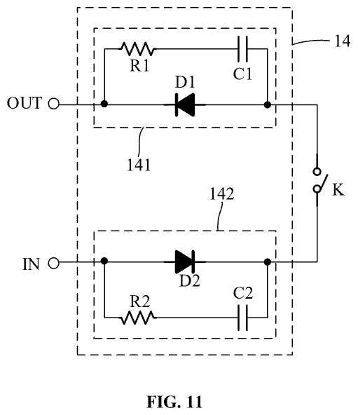

FIG. 10 is a flowchart of the electronic device control method according to some embodiments of the present disclosure. The method will be described in detail below.

71, after obtaining the startup signal, if it is determined that the user has not set a time threshold.

72, entering the second shutdown state after the duration of the first shutdown state reaches a fixed duration and/or the power of the power module 11 is less than the target threshold.

In some embodiments, if the user determines the set time threshold based on the trigger input, then based on the foregoing embodiments, the electronic device can be controlled to enter the second shutdown state. If the user has not set a time threshold, after obtaining a shutdown signal, the second shutdown state can be entered after the duration of the first shutdown state reaches a fixed duration and/or the power module has a power level less than a target threshold.

The control method shown in FIG. 10 may include the following two methods.

In the first method, the set time threshold may be determined in response to a user trigger input. If the duration of the electronic device being in the first shutdown state and the time threshold meet the preset condition, the electronic device can be controlled to be in the second shutdown state. If the electronic device is in the first shutdown state, the power module of the electronic device may provide power to the control system of the electronic device through the power circuit. If the electronic device is in the second shutdown state, the power module of the electronic device may stop providing power to the control system to enter the power saving mode.

In the second method, after obtaining the shutdown signal, if it is determined that the user has not set a time threshold, the electronic device may enter the second shutdown state after the duration of the first shutdown state reaches a fixed duration and/or the power level of the power module is less than a target threshold.

After the electronic device is turned off, based on whether the user sets a time threshold, the first method or the second method may be selected to control the electronic device to enter the second shutdown state.

Based on the control method provided in the foregoing embodiments, an embodiment of the present disclosure further provides an electronic device, which can perform the control method provided in the foregoing embodiments.

In some embodiments, the structure of the electronic device may be as shown in FIG. 1, which includes a control system 13 and a power module 11. The power module 11 is connected to the control system 13 via the power circuit 12. The control system 13 may be configured to determine the set time threshold in response to the user trigger input. If the duration of the electronic device in the first shutdown state and the time threshold meet the preset condition, the electronic device can be controlled to be in the second shutdown state.

In some embodiments, if the electronic device is in the first shutdown state, the power module 11 of the electronic device may provide power to the control system 13 of the electronic device through the power circuit 12. If the electronic device is in the second shutdown state, the power module 11 of the electronic device may stop providing power to the control system 13 to enter the power saving mode.

The electronic device provided in the embodiments of the present disclosure can control the process of entering the second shutdown state from the first shutdown state based on the time threshold set by the user. The process of the electronic device entering the second shutdown state from the first shutdown state can be adjusted based on different time thresholds such that users can set time thresholds based on usage needs to regulate the process.

In some embodiments, the control system 13 may be used to obtain the time threshold set by the user in the setting interface of the electronic device. After the time threshold is stored in the power control chip of the power module 11, the electronic device can be controlled to shut down in response to the shutdown signal such that the electronic device can be in the first shutdown state. Accordingly, the user can perform human-computer interaction through the setting interface of the electronic device to set the time threshold.

In some embodiments, the electronic device may also be shown in FIG. 8, in which the power module 11 may be connected to the power wake-up circuit 14. The power wake-up circuit 14 may be configured to generate a control signal to control the power module 11 to exit the power saving mode such that the power module 11 can provide power to the control system 13 and start the control system 13. In some embodiments, the power module 11 may provide power to the started control system 13 through the power circuit 12 to control the electronic device to start up through the control system 13. Accordingly, the control signal can be used as a startup signal. After the control system 13 controls the power module 11 to exit the power saving mode, the power supply path of the power module 11 to the control system 13 can be restored. After being started, the control system 13 can automatically control the electronic device to start up based on the power provided by the power module 11.

In the electronic device provided in the embodiments of the present disclosure, the power wake-up circuit 14 may be configured to start and generate a control signal after the trigger unit detects a preset user operation. In some embodiments, the trigger unit may be a startup button (e.g., the power button) of the electronic device or other preset buttons of the electronic device. In some embodiments, the trigger unit may be configured to detect the change of the attitude of the electronic device from folded to unfolded to identify the user operation.

In some embodiments, the startup button or other preset buttons of the electronic device may be connected to the power wake-up circuit 14 such that the startup button or other preset buttons of the electronic device can be used as a trigger unit.

In some embodiments, the trigger unit can be linked to the folding mechanism of the electronic device through a mechanical linkage structure such that the trigger unit can detect the attitude change of the electronic device from folded to unfolded to identify the user operation.

In some embodiments, when the electronic device is in the second shutdown state, the control system 13 and the power control chip of the power module 11 can be bypassed, and the power wake-up circuit 14 can be triggered by linking with the button or folding mechanism of the electronic device. There is no need for other external circuits and software control to realize the controlling of the power module 11 of the electronic device to exit the power saving mode in the second shutdown state.

Since the electronic device can control the power module 11 to exit the power saving mode and the second shutdown state when there is no external power supply connected, the electronic device can enter the second shutdown state anytime and anywhere based on usage needs to save battery power consumption. There is no need to worry about the power module 11 cannot be controlled to exit the power saving mode and the electronic device cannot be turned on when there is no external power source.

Based on the above description, if the electronic device enters the second shutdown state, the electronic device of the embodiments of the present disclosure can avoid the limitation of being activated only by connecting to an external power source. For the manufacturers, the operation of plugging and unplugging the external power source to activate the device is omitted. For consumers, users can activate new electronic devices without an external power source. Accordingly, users can activate the electronic devices as soon as they purchase the electronic devices for ease of use.

In addition, the electronic device can reduce the access time from the first shutdown state to the second shutdown state by setting a time threshold, which can improve the energy storage performance of the battery in the power module 11 without affecting the activation and use of the users. Before the electronic device is shipped or sold, the electronic device can be continuously in the second shutdown state, which can greatly improve the battery power preservation performance.

Further, in the second shutdown state, the consumption of the battery power in the power module 11 can be greatly reduced. Generally, the battery power consumption in the second shutdown state is approximately 1% of the power consumption in the first shutdown state. Therefore, based on the technical solutions of the embodiments of the present disclosure, the storage time of the electronic device can be extended, such that after the electronic device is turned on after a long storage time, it still has more power for use.

After the power module 11 of a conventional electronic device enters the power saving mode, the control system 13 will shut down as the power module 11 stops to output power. At this time, the electronic device cannot be turned on directly by pressing the power button of the electronic device, and the control system 13 can only be powered by connecting an external power source. The control system 13 can be powered by the external power source such that the power module 11 can exit the power saving mode based on the started control system 13. In the embodiments of the present disclosure, the power wake-up circuit 14 can generate a control signal to control the power module 11 to exit the power saving mode and start the control system 13. Without the external power source, the power module 11 can exit the power saving mode and start the control system 13, and the started control system 13 can directly control the startup of the electronic device based on the power provided by the power module 11.

FIG. 11 is a schematic structural diagram of an example power wake-up circuit according to some embodiments of the present disclosure. As shown in FIG. 11, the electronic device includes a trigger unit K, and the power wake-up circuit 14 is connected to the trigger unit K. The power wake-up circuit 14 can be used to start after the trigger unit detects a preset user operation and generate a control signal.

The power wake-up circuit 14 includes an input terminal IN and an output terminal OUT. The input terminal IN can be connected to a battery in the power module 11 or to a clock power supply of an RTC to provide an input voltage to the power wake-up circuit 14 through the battery or the clock power supply in the power module 11. The output terminal OUT can be connected to a power control chip in the power module 11. When the trigger unit K detects the user operation, a conductive path is formed between the input terminal IN and the output terminal OUT such that a control signal can be formed based on the input voltage of the input terminal IN and output through the output terminal OUT. The power control chip can control the switch in the power module 11 to turn on based on the control signal, thereby storing the path between the power module 11 and the power circuit 12, and can provide power to the control system 13 to start the control system 13.

The power wake-up circuit 14 includes a first function circuit 141 and a second function circuit 142. The first function circuit 141 and the second function circuit 142 can be used to enable the current to flow unidirectionally from the input terminal IN to the output terminal OUT after the power wake-up circuit 14 is turned on.

The first function circuit 141 includes a first diode D1. The anode of the first diode D1 is connected to one end of the trigger unit K and the cathode of the first diode D1 is connected to the output terminal OUT. The first function circuit 141 also includes a first resistor R1 and a first capacitor C1 connected in series between the anode and cathode of the first diode D1. The second function circuit 142 includes a second diode D2. The anode of the second diode D2 is connected to the input terminal IN and the cathode of the second diode D2 is connected to the other end of the trigger unit K. The second function circuit 142 also includes a second resistor R2 and a second capacitor C2 connected in series between the anode and cathode of the second diode D2.

The two function circuits in the power wake-up circuit 14 each have a diode to realize unidirectional current transmission when the power wake-up circuit 14 is turned on. The capacitor and resistor connected in series between the cathode and anode of the diode can buffer and protect the diode and suppress circuit oscillation.

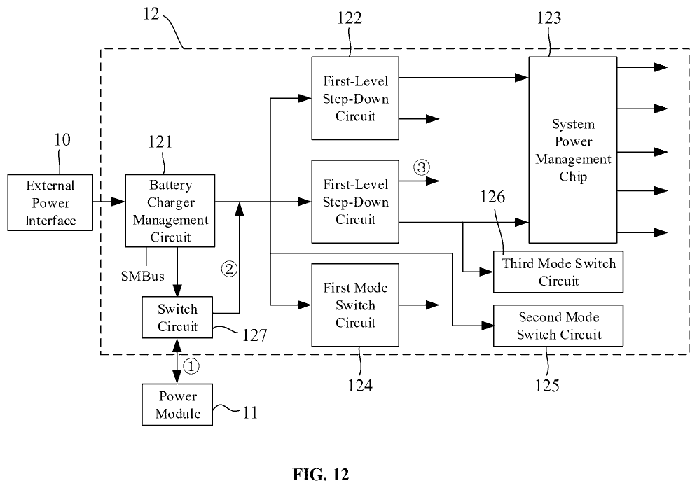

FIG. 12 is a schematic diagram of an example internal circuit connection of the electronic device according to some embodiments of the present disclosure. As shown in FIG. 12, the power circuit 12 includes a battery charger management circuit 121, a backend power supply circuit connected to the battery charger management circuit 121, and a switch circuit 127. The backend power supply circuit is connected to the control system 13, which is not shown in FIG. 12. The power module 11 is connected to the backend power supply circuit via the switch circuit 127.

In some embodiments, the battery charger management circuit 121 may be a buck-boost converter. A frontend of the battery charger management circuit 121 is connected to an external power interface 10 for connecting to an external power source.

The switch circuit 127 is connected to the battery charger management circuit 121 such that the battery charger management circuit 121 can control the conduction state of the switch circuit 127. When the external power interface 10 connected to the battery charger management circuit 121 is connected to an external power source, the backend power supply circuit can operate with the power provided by the external power source. When the external power source is not connected, the power module 11 can provide power to the backend power supply circuit.

The backend power supply circuit includes a plurality of first-level step-down circuits 122 for system power supply. The first-level step-down circuits 122 are connected to the switch circuit 127 and the battery charger management circuit 121 respectively to facilitate the input of the required working voltage based on the external power source or the power module 11, and the output of the electrical signal after the first-level step-down. The backend power supply circuit also includes a system power management chip (SYS PMIC) 123 connected to the first-level step-down circuit 122. The system power management chip can be used as a second-level step-down circuit, and can output multiple different electrical signals based on the electrical signal output by the first-level step-down circuit 122. The backend power supply circuit also includes a plurality of mode switch circuits. The plurality of mode switch circuits include a first mode switch circuit 124, a second mode switch circuit 125, and a third mode switch circuit 126. The first mode switch circuit 124 is connected to the switch circuit 127 and the battery charger management circuit 121 respectively to provide power to the CPU core based on the required working voltage input by the external power source or the power module 11. The second mode switch circuit 125 is connected to the switch circuit 127 and the battery charger management circuit 121 respectively to provide power to the CPU based on the required working voltage input by the external power source or the power module 11. The third mode switch circuit 126 is connected to the first-level step-down circuit 122 to provide power to the CPU based on the electrical signal input by the first-level step-down circuit 122.

The control system includes system control chips on the device motherboard, such as EC, PCH (e.g., an integrated south bridge chip), the central processing unit (CPU) and other system control chips. In the circuit shown in FIG. 12, the power module 11 can supply power to the EC and PCH via line \textcircled{1} between the power module 11 and the switch circuit 127, line \textcircled{2} between the switch circuit 127 and the backend power supply circuit, and a target output line \textcircled{3} of the first-level step-down circuit 122 to maintain the power supply to the control system 13 in the first shutdown state. The target output line \textcircled{3} may have an output voltage of 3 V and a current of 100 mA. Take a laptop as an example. In the shutdown state, the power module 11 uses line \textcircled{1} between the power module 11 and the switch circuit 127, line \textcircled{2} between the switch circuit 127 and the backend power supply circuit, and the target output line \textcircled{3} as the EC and PCH power modes corresponding to the S5 state set by the system.

It should be noted that in the embodiments of the present disclosure, the implementation of the power circuit 12 is not limited to the embodiment shown in FIG. 12. In the embodiments of the present disclosure, the power circuit 12 can also adopt the existing system power architecture of current electronic devices.

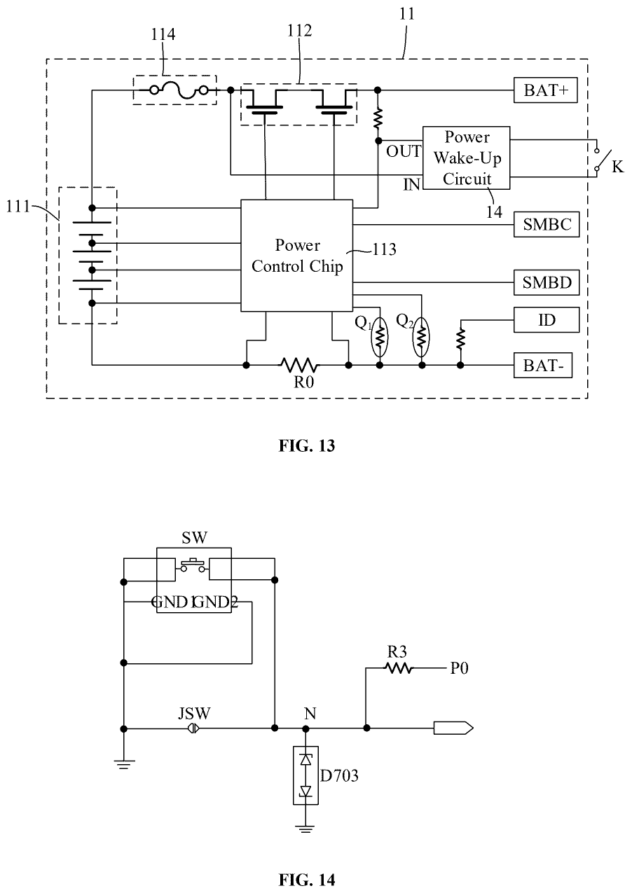

FIG. 13 is a circuit diagram of an example power module according to some embodiments of the present disclosure. Based on any of the foregoing embodiments, and in combination with FIG. 8, FIG. 11 and FIG. 13, the power module 11 includes a battery 111 and a power control chip 113. The battery 111 is connected to the power circuit 12 via a switch 112. In the power saving mode, the switch 112 is closed. The power control chip 113 is used to respond to the control signal and turn on the switch 112 to control the power module 11 to exit the power saving mode. When the power control chip 113 inputs a control signal, the switch 112 can be controlled to conduct based on the control signal, thereby restoring the conductive path between the battery 111 and the power circuit 12, and providing power to the control system 13 to start the control system 13.

The power module 11 includes a positive power output terminal BAT+ for connecting the power circuit 12, and the switch 112 is connected between the cathode of the battery 111 and the positive power output terminal BAT+.

In the embodiment shown in FIG. 13, the power wake-up circuit 14 is connected to the power module 11 and outputs a control signal base on the voltage of the battery 111. An input terminal of the power wake-up circuit 14 is connected to the battery 111 for the battery 111 to provide an input voltage for the power wake-up circuit 14. At this time, the input terminal IN of the power wake-up circuit 14 can be connected to the line connecting the power module 11 and the switch 112, and the battery 111 can provide the input voltage for the power wake-up circuit 14 which is not controlled by the switch 112.

In some embodiments, to improve integration, the power wake-up circuit 14 can be integrated into the power module 11 and packaged and protected together with the power module 11. In other embodiments, the power wake-up circuit 14 can also be arranged outside the power module 11, such as on the mainboard.

In some embodiments, the power wake-up circuit 14 may also be arranged to connect to the clock power source in the electronic device, and output a control signal based on the voltage of the clock power source. At this time, the input terminal IN of the power wake-up circuit 14 can be connected to the clock power source to provide the input voltage for the power wake-up circuit 14 based on the clock power source.

As shown in FIG. 13, the power module 11 includes a detection resistor R0, a fuse 114, a first sensor Q1, and a second sensor Q2. The detection resistor R0 is connected between the anode of the battery 111 and the negative output terminal BAT− of the power source for detecting the working current of the power module 11. The fuse 114 connects the switch 112 and the cathode of the battery 111. The first sensor Q1 is connected between the negative output terminal BAT− of the power source and the power control chip 113, and is used to detect the temperature of the battery 111. The second sensor Q2 is connected between the negative output terminal BAT− of the power source and the power control chip 113, and is used to detect the temperature of the switch 112. The switch 112 includes a MOS, and the second sensor Q2 can detect the temperature of the MOS.

The power control chip 113 can control the conduction state of the switch 112 based on the detection results of the detection resistor R0, the first sensor Q1 and the second sensor Q2, and control the fuse 114 to melt when a serious fault occurs.

The power module 11 further includes a clock port SMBC and a data port SMBD respectively connected to the power control chip 113; and an identification port ID connected to the negative output terminal BAT− of the power source. The control system 13 can monitor the working state of the power module 11 based on the clock port SMBC and perform functional control of the power module 11. The control system 13 can perform data exchange with the power module 11 based on the data port SMBD. The electronic device can identify and configure the power module 11 based on the identification port ID of the power module 11.

In some embodiments, the power control chip 113 may include a power meter chip (i.e., a gauge). The power meter chip can be combined with the primary protection circuit and the second protection circuit to control the working state of the fuse 114 and the switch 112. In other embodiments, the power control chip 113 may also be a microcontroller (MCU).

Since chip packages generally have floating pins with no circuit connection (no connection, NC). In some embodiments, the trigger unit can be connected by using the floating pin of the power control chip 113, and the circuit connection between the power wake-up circuit 14 and the power module 11 can be realized based on the floating pin.

Take the switch 112 including PMOS as an example. In this case, the default state of the floating pin can be set to a high level. When the trigger unit is triggered to detect the preset user operation, the floating pin can be switched to a low level as a control signal to control the switch 112 to conduct. Accordingly, a path is formed between the battery 111 and the positive power output terminal BAT+ such that the power module 11 can supply power to the outside through the positive power output terminal BAT+.

Accordingly, there is no need to change the circuit structure of the power module 11, and the power module 11 can operate based on software settings. When there is a time threshold set by the user, the process of switching from the first shutdown state to the second shutdown state can be controlled based on the time threshold. When there is no time threshold set by the user, the process of switching from the first shutdown state to the second shutdown state can be controlled based on the fixed control method provided by the system. Likewise, there is no need to change the circuit structures of the power circuit 12 and the control system 13. The control system 13 can operate based on software settings. When there is a time threshold set by the user, the time threshold can be stored in the power control chip 113 of the power module such that the power control chip 113 can control the process of switching from the first shutdown state to the second shutdown state based on the time threshold.

The input terminal IN of the power wake-up circuit 14 may be connected to the battery 111 or the clock power supply to obtain the working voltage. The output terminal OUT of the power wake-up circuit 14 may be connected to the control pin of the power control chip 113. That is, when the power wake-up circuit 14 outputs the control signal, the power control chip 113 can be turned on to turn on the switch 112 such that the power module 11 can exit the power saving mode. The power wake-up circuit 14 can be directly connected to the existing circuit port, and there is no need to change the circuit structure and connection relationship of the existing power module 11, the power circuit 12 and the control system 13 of the electronic device.

In the embodiments of the present disclosure, the power button of the electronic device can be reused as the trigger unit. At this time, based on the triggering of the power button once, the power wake-up circuit 14 can be turned on to control the power module 11 to exit the power saving mode, and cause the electronic device to be turned on. After the electronic device exits the second shutdown state, the power button can be controlled to turn on without being triggered again.

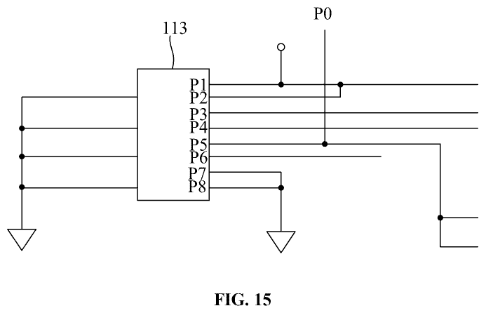

When the power button is reused as a trigger unit, the connection between the power button and the power control chip 113 can be as shown in FIG. 14 and FIG. 15. FIG. 14 is a schematic diagram of an example circuit connection of a power button according to some embodiments of the present disclosure, and FIG. 15 is a schematic diagram of an example pin connection method of a power control chip according to some embodiments of the present disclosure.

As shown in FIG. 14, one end of the power button SW is grounded, and the other end is connected to the node N. The node N can be connected to the node P0 through the resistor R3, thereby connecting the corresponding pin of the power control chip 113 based on the node P0. Node N can be grounded via the switch JSW. The switch JSW can be used as a jumper switch to change the connection relationship and configuration of the circuit connected to the power button SW. Node N can be grounded through a protection circuit D703, and the protection circuit D703 can be used to improve the electromagnetic compatibility (EMC) of the electronic device and reduce electromagnetic interference to the external environment.

As shown in FIG. 15, the power control chip 113 at least includes pins P1 to P8, where pins P1 and P2 serve as a positive power output terminal BAT+, pins P7 and P8 serve as a negative power output terminal BAT−, and pin P5 is connected to node P0. If the electronic device is in the second shutdown state, the power control chip 113 can detect that the power button SW is triggered based on pin P5, and then output a control signal through pin P6 to turn on the switch 112.

Various embodiments of the present disclosure are described in a progressive manner, or in a parallel manner, or in a combination of progressive and parallel manners. Each embodiment may focus on differences from other embodiments, and same and similar parts between various embodiments may be referred to each other.

In the description of embodiments of the present disclosure, the description of the drawings and embodiments are illustrative and not restrictive. The same reference numerals represent the same structure throughout the specification. In addition, to facilitate understanding and description, the thicknesses of some layers, films, panels, and areas can be exaggerated in the drawings. Meanwhile, when an element such as a layer, a film, an area, or a substrate is described as on another element, the element can be directly on the another element or an intermediate element can exist. In addition, “on” represents that the element is positioned on the another element or under the another element, which does not indicate that the element is positioned on an upper side of the another element in a gravity direction.

In the description of the present disclosure, orientation or positional relationship indicated by the terms upper”, “lower”, “top”, “bottom”, “inner”, “outer” and the like which is based on the orientation or positional relationship shown in the drawings may be merely for the convenience of describing the present disclosure and simplifying the description, rather than indicating or implying that indicated device or element must have a specific orientation, be constructed and operated in a specific orientation; therefore, it should not be understood as a limitation on the present disclosure. When a component is “connected” to another component, it may be directly connected to another component or there may be a centered component at the same time.

It should also be noted that in the present disclosure, relational terms such as first, second and the like may be merely used to distinguish one entity or operation from another entity or operation and may not necessarily require or imply any such actual relationship or order between these entities or operations. Moreover, the terms “include”, “contain” or any other variations thereof may be intended to cover non-exclusive inclusion, so that a process, method, article, or equipment that includes a series of elements includes not only those elements, but also other elements that are not explicitly listed, or also includes elements inherent to the process, method, article, or equipment. If there are no more restrictions, the elements defined by the sentence “include a . . . ” does not exclude the existence of other same elements in the process, method, article, or equipment that includes the elements.

Above description of disclosed embodiments may enable those skilled in the art to make or use the present disclosure. Various modifications to these embodiments may be readily apparent to those skilled in the art, and the generic principles defined herein may be implemented in other embodiments without departing from the spirit or scope of the present disclosure. Therefore, the present disclosure may not be intended to be limited to embodiments of the present disclosure but may be accorded the widest scope consistent with the principles and novel features disclosed herein.

What is claimed is:

1. A control method for an electronic device comprising:
determining a set time threshold in response to a user trigger input;
if a duration of the electronic device being in a first shutdown state and the time threshold meet a preset condition, controlling the electronic device to be in a second shutdown state;
if the electronic device is in the first shutdown state, causing a power module of the electronic device to provide power to a control system of the electronic device through a power circuit; and
if the electronic device is in the second shutdown state, causing the power module of the electronic device to stop providing power to the control system and causing the electronic device to enter a power saving mode.

2. The control method of claim 1, wherein setting the time threshold includes:
setting the time threshold on a setting interface of the electronic device;
storing the setting of the time threshold; and
controlling the electronic device to shut down to be in the first shutdown state based on a shutdown signal.

3. The control method of claim 1, when the electronic device is in the second shutdown state, further comprising:
based on a control signal, controlling the power module to exit the power saving mode to provide power to the control system through the power module, and start the control system, wherein:
the power module is configured to provide power to the control system after startup through the power circuit to control the electronic device to start up through the control system.

4. The control method of claim 3, wherein:
based on a preset user operation, turning on a power wake-up circuit connected to eh power module to generate the control signal through the power wake-up circuit.

5. The control method of claim 1 further comprising:
if it is determined that the user has not set the time threshold after obtaining the shutdown signal, causing the electronic device to enter the second shutdown state after a duration of the first shutdown state reaches a fixed duration and/or a power level of a battery in the power module being less than a target threshold.

6. An electronic device comprising:
a control system; and
a power module, the power module being connected to the control system via a power circuit, the control system being configured to respond to a user trigger input, determine a set time threshold, and if a duration of the electronic device in a first shutdown state and the time threshold meet a preset condition, control the electronic device to be in a second shutdown state, wherein:
if the electronic device is in the first shutdown state, the control system is configured to cause the power module of the electronic device to provide power to the control system of the electronic device through the power circuit; and
if the electronic device is in the second shutdown state, the control system is configured to cause the power module of the electronic device to stop providing power to the control system and cause the electronic device to enter a power saving mode.

7. The electronic device of claim 6, wherein:
the control system is configured to obtain the time threshold set by the user in a setting interface of the electronic device, store the time threshold in a power control chip of the power module, and respond to a shutdown signal to control the electronic device to shut down to cause the electronic device to be in the first shutdown state.

8. The electronic device of claim 6, wherein:
the power module is connected to a power wake-up circuit for generating a control signal to control the power module to exit the power saving mode to start the control system; and
the power module is configured to provide power to the control system after startup through the power circuit to control the electronic device to start up through the control system.

9. The electronic device of claim 8, wherein:
the power wake-up circuit is configured to start after a trigger unit detects a preset user operation and generate the control signal, the trigger unit being a power button of the electronic device or other preset buttons of the electronic device; and/or,
the trigger unit being configured to detect change of an attitude of the electronic device from being folded to unfolded to identify the user operation.

10. The electronic device of claim 8, the power module comprising:
a battery, the battery being connected to the power circuit via a switch, the switch being close in the power saving mode; and
the power control chip connected to the switch, the power control chip being configured to respond to the control signal and turn on the switch to control the power module to exit the power saving mode, wherein:
the power wake-up circuit is connected to the battery and outputs the control signal based on a voltage of the battery; or,
the power wake-up circuit is connected to a clock power supply in the electronic device, and outputs the control signal based on a voltage of the clock power supply.

11. A computer readable storage medium storing one or more computer program instructions, when executed by one or more processors, the computer program instructions implementing a control method for an electronic device, the method comprising:
determining a set time threshold in response to a user trigger input;
if a duration of the electronic device being in a first shutdown state and the time threshold meet a preset condition, controlling the electronic device to be in a second shutdown state;
if the electronic device is in the first shutdown state, causing a power module of the electronic device to provide power to a control system of the electronic device through a power circuit; and
if the electronic device is in the second shutdown state, causing the power module of the electronic device to stop providing power to the control system and causing the electronic device to enter a power saving mode.

12. The computer readable storage medium of claim 11, wherein setting the time threshold includes:
setting the time threshold on a setting interface of the electronic device;
storing the setting of the time threshold; and
controlling the electronic device to shut down to be in the first shutdown state based on a shutdown signal.

13. The computer readable storage medium of claim 11, wherein when the electronic device is in the second shutdown state, the method further comprising:
based on a control signal, controlling the power module to exit the power saving mode to provide power to the control system through the power module, and start the control system, wherein:
the power module is configured to provide power to the control system after startup through the power circuit to control the electronic device to start up through the control system.

14. The computer readable storage medium of claim 13, wherein the method further comprises:
based on a preset user operation, turning on a power wake-up circuit connected to eh power module to generate the control signal through the power wake-up circuit.

15. The computer readable storage medium of claim 11, wherein the method further comprises:
if it is determined that the user has not set the time threshold after obtaining the shutdown signal, causing the electronic device to enter the second shutdown state after a duration of the first shutdown state reaches a fixed duration and/or a power level of a battery in the power module being less than a target threshold.
